(19) United States
(12) Patent Application Publication
(10) Pub. No.: US 2012/0124661 A1
(43) Pub. Date: May 17, 2012

(54) METHOD FOR DETECTING A WEB APPLICATION ATTACK

(75) Inventors: Seok Woo Lee, Seoul (KR); Duk Soo Kim, Seoul (KR); Young In Park, Yooungin-si (KR); Hae Min Park, Seoul (KR)

(73) Assignee: Penta Security Systems, Inc., Seoul (KR)

(21) Appl. No.: 12/876,820

(22) Filed: Sep. 7, 2010

(30) Foreign Application Priority Data
Jul. 5, 2010 (KR) 10-2010-0064363

(51) Int. Cl. G06F 11/00; G06F 17/00

(52) U.S. Cl. 726/13

(57) ABSTRACT

A method of detecting a web application attack is provided. The method includes the steps of when packets forming HTTP traffic are received, a web application firewall recombining the HTTP traffic, analyzing the recombined HTTP traffic and determining whether or not the recombined HTTP traffic includes the attack-relevant content, if the recombined HTTP traffic does not include the attack-relevant content, sending the recombined HTTP traffic to a web server or a user server and normally processing the recombined HTTP traffic, and if the recombined HTTP traffic includes the attack-relevant content, detecting the recombined HTTP traffic as an attack and reprocessing the same.

### BACKGROUND OF THE INVENTION

1. Field of the Invention

The present invention relates, in general, to a method of detecting a web application attack.

2. Description of the Related Art

Conventionally, a web application firewall (hereinafter briefly called ‘WAF’) protects an attack on a layer 7 that corresponds to an uppermost layer in a 7-layer model according to classification criteria of a network by the Open Systems Interconnection (OSI), based on an Intrusion Detection System (IDS) or an Intrusion Protection System (IPS) that carries out detecting an attack at a layer 4 of the OSI 7-layer model, and therefore a limit becomes generated upon a defense against the attack.

FIG. 1 shows an illustration for explaining the conventional OSI 7-layer model.

As shown in FIG. 1, the OSI 7-layer model is used in categorizing protocols and methods in architectural models of computer networking and includes Application Layer, Presentation Layer, Session Layer, Transport Layer, Network Layer, Data link Layer, and Physical Layer. The reasons why a Web Application Firewall (WAF) that detects and protects an attack on the layer 7 are as follows.

First, since systems such as an Intrusion Detection System (IDS) or an Intrusion Protection System (IPS) that were generally used in detecting an attack are devised by an attempt to expand, to a packet analysis, a function of a network firewall which only served to block a specific port for a specific Internet Protocol (IP) Address, the location where the network firewall had detected an attack is the layer 4.

Further, the location where a meaningful minimal data unit, a packet, which is not a meaningless electric signal, first appears on the OSI 7-layer model is the layer 4, so that at the layer 4 at which a first data unit is established, the attack is determined and blocked.

That is, while an intellectual web firewall can serve to minimize a false positive and a false negative only when an analysis of network traffic also has to be performed at the level of the layer 7 to detect and protect an attack on Application Layer (Layer 7; L7), according to the prior art, such an attack on the layer 7 was detected by a detecting method on a level of Layer 4, so that normal detection and protection could not be performed.

Specifically, Layer 4 has a packet as a data unit, and first, second generation WAFs, established based on the conventional IDS and IPS, determine whether or not an attack has been conducted upon corresponding network traffic by performing a pattern matching in a unit of a packet. That the conventional first, second generation WAFs determine either a normal packet or an attacking packet by checking whether or not the respective packets correspond to those of average 5000 numbers of attack patterns (Regular Expression: Regx), which are previously registered by a manager.

While recently developed WAFs use a Deep Packet Inspection (DPI) method with which the payload part of a packet is also inspected whereas according to the conventional method, only a header of a packet is inspected to determine the existence of an attack. However, this is not a true protection method in the level of Application Layer, but merely an advanced method in the level of Level 4 according to the related art.

Meanwhile, the conventional attack detecting method, which is carried out in the level of Layer 4, while being adapted to an attack detecting method in the level of Application Layer (Layer 7), has the four limits as follows.

First, new attack patterns should be updated whenever the attack pattern varies.

Second, since the number of the attack patterns which can be registered in connection with a processing speed is restricted (maximum number is 10,000), the previously-registered attack patterns should be deleted periodically.

Third, it is hard to technically modulate an attack packet (e.g. deletion of a specific part of personal information, such as modulation, deletion, etc. of HTML tag) in the conventional WAF based on a packet pattern matching in a Layer 4.

The reason is as follows. The packet modulation causes variation in a packet size. Then, for the first, second generation WAFs, so many operations are required in performing reregistering varied packet size to a packet header, thereby increasing the processing time, which makes it difficult to adapt to an actual environment of Internet service.

Fourth, since the conventional method determines an attack by checking not the whole, but a part of the HTTP traffic, semantically it may make an error such as determining a not-attacking packet as an attacking packet.

### SUMMARY OF THE INVENTION

Accordingly, the present invention has been made keeping in mind the above problems occurring in the related art, and the present invention is intended to propose a method of detecting a web application attack, in which only the payload is separated from the packets of the received HTTP traffic, the HTTP traffic is recombined, and the content of the recombined HTTP traffic is analyzed using a parser to determine whether or not the recombined HTTP traffic includes the attack-relevant content.

In order to achieve the above object, according to one aspect of the present invention, there is provided a method of detecting a web application attack, the method including: when packets forming HTTP traffic are received, a web application firewall recombining the HTTP traffic; analyzing the recombined HTTP traffic and determining whether or not the recombined HTTP traffic includes the attack-relevant content; if the recombined HTTP traffic does not include the attack-relevant content, sending the recombined HTTP traffic to a web server or a user server and normally processing the recombined HTTP traffic; and if the recombined HTTP traffic includes the attack-relevant content, detecting the recombined HTTP traffic as an attack and reprocessing the same.

As set forth before, according to the present invention, only the payload is separated from the packets of the received HTTP traffic, the HTTP traffic is recombined, and the content of the recombined HTTP traffic is analyzed using a parser to determine whether or not the recombined HTTP traffic includes the attack-relevant content, thereby reducing a false positive rate.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is an illustration for explaining a general OSI 7-Layer model;

FIG. 2 is an illustration of the configuration of a communication system to which the present invention is adapted;

FIG. 3 is a flow chart showing an exemplary procedure of a method of detecting a web application attack according to an embodiment;

FIG. 4 is an illustration for explaining the meaning of recombination of HTTP traffic which is adapted to the method of the invention; and

FIGS. 5A to 5D are illustrations for explaining a function of a SQL parser which is adapted to the invention.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

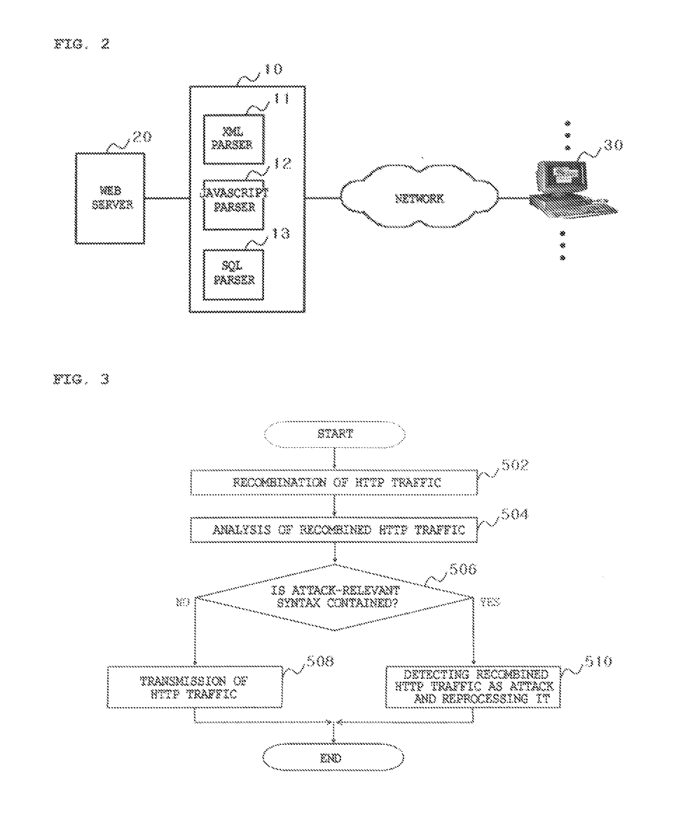

FIG. 2 is an illustration of the configuration of a communication system to which the present invention is adapted.

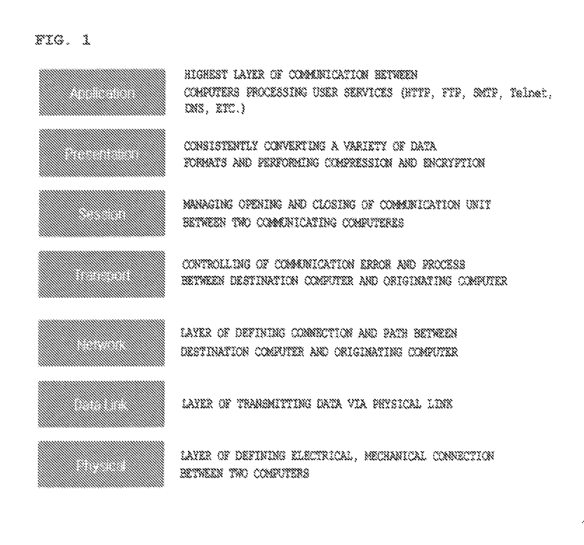

As shown in FIG. 1, the communication system includes a web server 20 that manages a web site to provide a variety of services to users, a user server 30 that communicates with the web server to receive and send a variety of information from and to the web server, and an web application firewall (WAF) 10 that connects the web server to the user server across a network, and detects an attack from the user server to protect a function of the web server.

Here, the user server may be a personal computer (PC), or otherwise a server which communicates with the plurality of PCs across a network.

Meanwhile, the WAF 10 to which the detecting method of a web application attack is adapted to protect the web server from an external attack, as shown in FIG. 2, includes an XML parser 11, a JavaScript parser 12, and a SQL parser 13.

That is, the detecting method of the web application attack is a method in which the WAF collects only payload parts from the received HTTP traffic, with header parts of packets removed, recombines the HTTP traffic, and then performs a semantic analysis to the recombined HTTP traffic to detect the existence of an attack. The method has the following advantages.

First, even though an attack pattern varies, there is no need to register a new attack pattern.

Second, since there is no concept of stored pattern, there is no need to delete existing attack patterns.

Third, the existence of an attack is determined by checking the whole of the HTTP traffic, and if the attack is determined to be done, recombined HTTP traffic can be modulated and sent. That is, e.g. the cancellation of social security number and the modulation of html and JavaScript tag may be conducted.

Fourth, since the existence of an attack is determined through the semantic analysis to the whole of the recombined HTTP traffic, without checking only packets, the false positive rate can be considerably reduced.

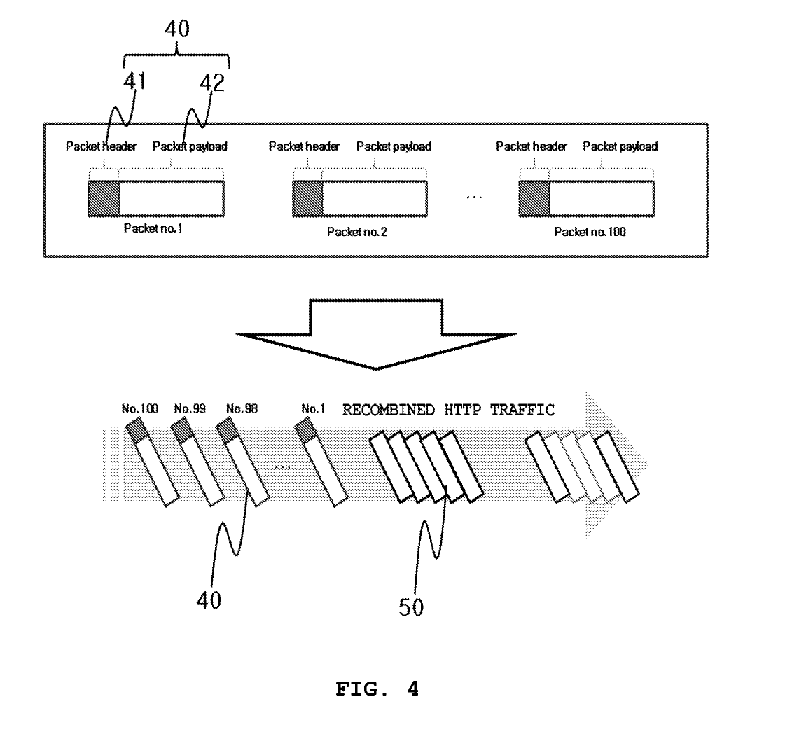

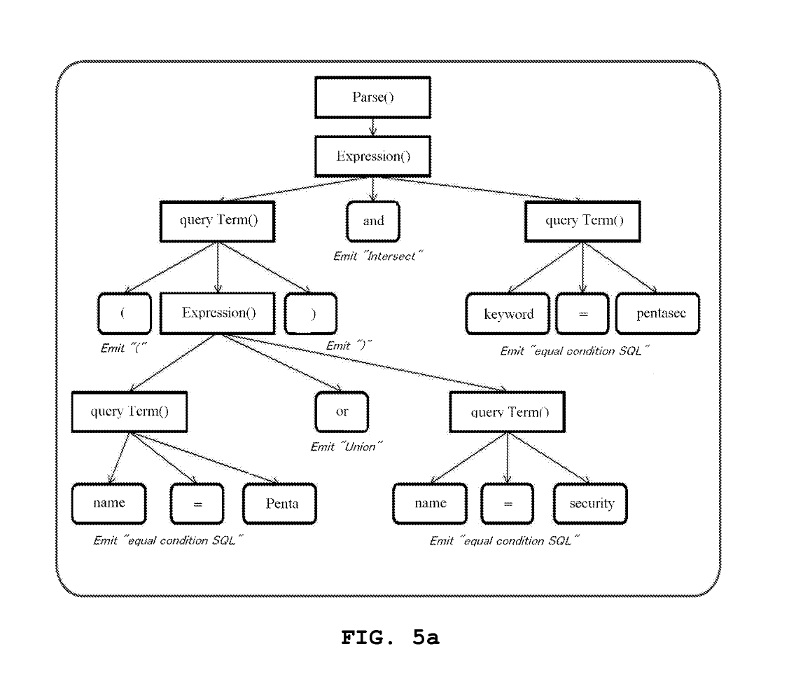

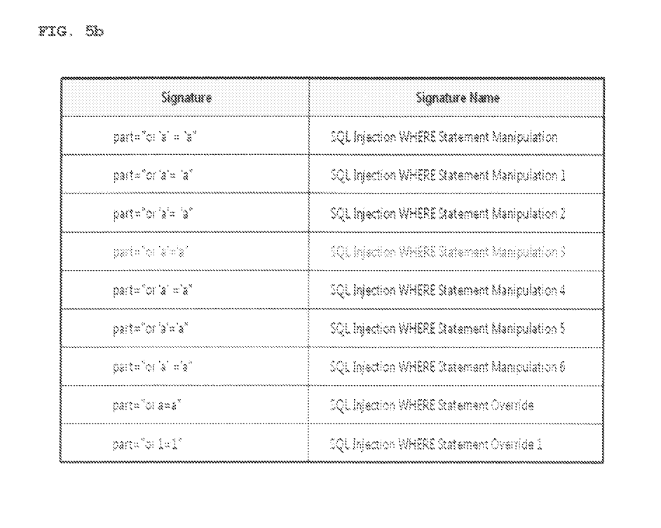

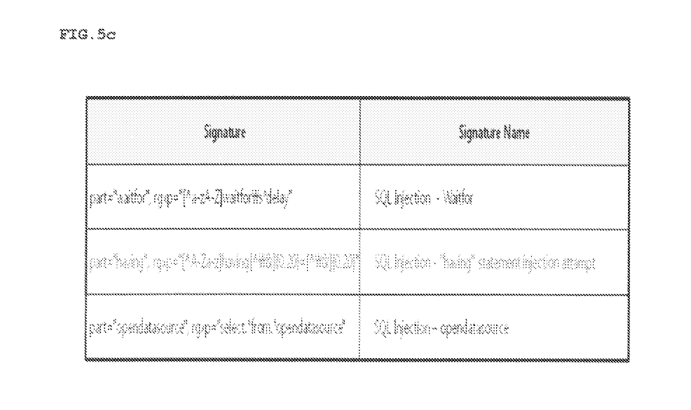

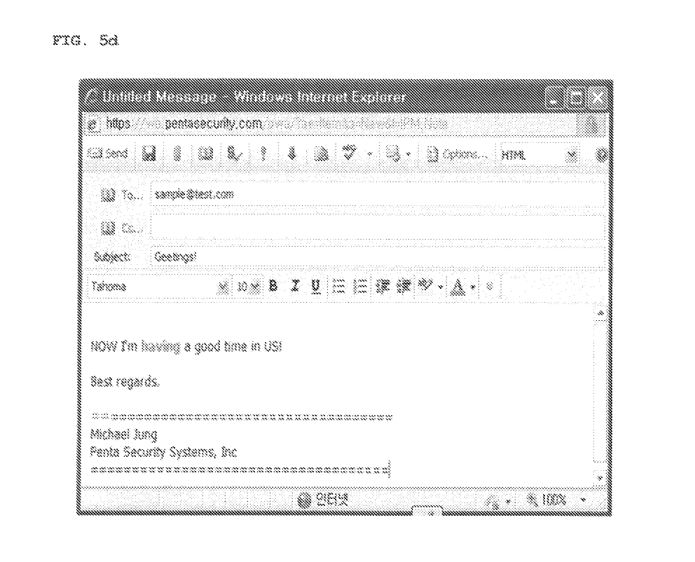

FIG. 3 is a flow chart showing an exemplary procedure of a method of detecting a web application attack according to an embodiment, FIG. 4 is an illustration for explaining the meaning of recombination of HTTP traffic which is adapted to the method of the invention, and FIG. 5A to 5D are illustrations for explaining a function of the SQL parser which is adapted to the invention.

In the first step, when packets forming HTTP traffic are received during network-communication with external servers, the WAF aligns the packets in sequence, removes headers of the respective packets to leave only payload parts of the respective packets, and recombines the HTTP traffic using the payload parts (502). Here, the recombination of the HTTP traffic means the collecting of only the payload parts through analyzing the header parts of the packets and aligning the packets in sequence. That is, the recombination means that as shown in FIG. 4, the respective packets are arranged in order of their sequence, and only the payload parts 42 of the packets 40 are combined. That is, as shown in FIG. 4, the packets 40, forming the HTTP traffic, each consist of a header part 41 and a payload part 42, so that according to the present invention, only the payload parts are separated from the packets and the HTTP traffic is recombined using the payload parts. Specifically, the HTTP traffic comes to a destination computer (or server) while their data being furthermore divided into sub data units as it comes to a lower layer, e.g. L7 (Layer 7)→L6→L5→L4→L3→L2→L1. The data unit at L4 is a packet. Here, in the packet, the header part (also referred to as a ‘header’) contains information such as the sequence of the packet, and the payload part (also referred to as ‘payload’) contains the actual data such as the part of the source and destination of the material transmitted over a network. The present invention recombines only the payload parts of the respective packets.

That is, the WAF is provided for protecting an attack to a web server which manages a web site, and the essential elements for configuring the web site are generally XML, JavaScript, and SQL, so that the WAF to which the present method is adapted may be composed of three kinds of parsers, including an XML parser, a JavaScript parser, and a SQL parser. The kinds of the parsers may diversely vary according to change in a standard of a web site.

Here, XML is a high-order language of DHTML and HTML, which is a markup language that ensures integrity and high/low-order concepts of document based on tag. The XML parser checks the start point and end point of tag for recombined HTTP traffic to confirm the integrity and high/low-order concepts of the XML syntaxes, and serves to determine whether or not the recombined HTTP traffic contains the attack-relevant content.

The JavaScript parser serves to analyze JavaScript, one of the computer programming languages (C, Java, Phyton, or the like) and convert it into binary numbers, a computer-readable form. The JavaScript parser implements the ECMAScript language standard and if certain syntaxes are contrary to the standard, corresponding JavaScript syntaxes are unreadable by a computer and an error arises. The conventional WAFs determined the existence of attacking syntaxes using JavaScript by checking the existence of <script> Tag, which indicates the start of JavaScript syntax, without analyzing the JavaScript syntaxes. However, according to the present invention, it is determined whether or not the corresponding JavaScript syntaxes are effective syntaxes using EMCA-262 standard JavaScript parser (decoder). Further, since in the conventional case, at L4, the whole of JavaScript HTTP traffic could not be checked, there was no method for checking the effectiveness of the JavaScript syntaxes. However, the invention can do it by recombining the HTTP traffic as described above and analyzing the recombined HTTP traffic using the JavaScript parser. That is, JavaScript parser checks JavaScript syntaxes, which follow the EMCA-262 standard, to determine whether or not the JavaScript syntaxes are effective.

The SQL parser serves to determine whether or not the HTTP traffic contains the attacking syntaxes by sub-dividing the recombined HTTP traffic into minimal units and checking whether or not the divided units belong to part of the SQL syntaxes. The function of the SQL parser will now be described with reference to FIGS. 5A to 5D. In the case that as an example of attack-detection using the SQL parser, the SQL injection attacking syntax is (name=“penta” or name=“security”) and keyword=“pentasec”, the SQL parser sub-divides the SQL injection syntax into minimal units of the SQL standard as shown in FIG. 5A, and detects the existence of an attack for each minimal unit. Here, if the minimal units belong to part of the SQL commands, the whole of corresponding syntaxes is determined to be the SQL syntaxes. On the contrary, the conventional WAF uses the method that a variety of patterns (signatures) are previously registered, so that as shown in FIG. 5B, the SQL injection attacking syntax varies from ‘a’=‘a’ to ‘b’=‘b’, for example, a problem arises in that such a case cannot be protected. Further, in the case that the conventional WAF which uses the above method has registered a pattern (signature) as shown in FIG. 5C, if Request HTTP traffic, transmitted to a server by a user, contains the syntax such as “ . . . having a good time . . . == . . . ”, the conventional WAF will determine it as an SQL injection attacking syntax because of the existence of a mark, ==, after a word of having, which may cause a problem of false positive.

That is, the XML parser detects an attack by performing an analysis on the recombined HTTP traffic, and the SQL parser does it by sub-dividing the attacking syntaxes into minimal units and checking whether the minimal units belong to part of the SQL.

Fourth, if the determination result (506) indicates that the attack-relevant content is not contained, the WEF transmits the recombined HTTP traffic to the web server, or otherwise to the user server via a network, such that the recombined HTTP traffic is normally processed (508).

Fifth, if the determination result (506) indicates that the attack-relevant content is contained, the WAF determines that the recombined HTTP traffic or the packets contained in the recombined HTTP traffic are not normal, and detects the recombined HTTP traffic as an attack, and also reprocesses the abnormal recombined HTTP traffic (510). Here, the reprocessing of the abnormal recombined HTTP traffic may be performed by two methods. First, the web server or the user server, which transmitted the abnormal packets, is requested to retransmit the packets corresponding to the abnormal packets, or otherwise the packets are deleted. Second, the abnormal packets are modulated and transmitted. Hereinafter, the second method will be described in more detail.

That is, in the case that a normal message, that a user intends (Request) to do a transmission to the web server 20 on a network using the user server 30, contains the syntax (e.g. <script>) to be suspected of an attack, even though the user does not intend to make an attack, the conventional WAF determined it as an attack and could block the user's request. However, in this case, if the present WAF changes ‘<script>’ Tag into e.g. ‘[script]’, the attacking syntax becomes unavailable, thereby preventing the false positive on the user's normal action.

Further, in the case that a response message, transmitted from the web server 20 to the user server 30, contains personal information, if the page is blocked for the reason of only containing the simple personal information, a user cannot also view other information that does not contain personal information. In this case, the present WAF 10 masks only the part of containing the personal information (e.g. 76****-11*****) so as to allow other messages, which are irrelevant to the personal information, to be normally transmitted (response) to a user. That is, the invention serves to detect an attack from externally transmitted web traffic, and also to prevent the leakage of personal information, such as social security number, credit card number, address, e-mail account, incorporation certification number, employer's identification number, or the like, through modulation (masking) of the web traffic. To this end, according to the invention, the WAF characteristically modulates part of a personal information-relevant message among the messages contained in the recombined web traffic (HTTP traffic) into a message unreadable by an external source.

Additionally, the meaning of the recombined HTTP traffic is that the header parts of the packets are analyzed and the packets are arranged in order of their sequence, which means the state of the original message intended to first transmit at L7 being recovered.

Thus, at least one of the parsers of the WAF analyzes the content of the recombined HTTP traffic to determine the existence of the attacking syntaxes so that if a packet contains the attacking syntaxes or the like and is determined to be abnormal, a transmitting network server is requested to retransmit a corresponding packet, and the WAF may repeat the processes of receiving the corresponding packet, removing the header part of the packet as described above, and recombining the HTTP traffic (502), or otherwise may delete or modulate only the content relevant to an attack in the corresponding packet, and transmit the packet.

Next, two relevant examples will be described with reference to Tables 1 and 2.

TABLE 1
[First example of a semantic detection engine using a parser]

Cross Site Scripting (XSS) attacking syntax : <script

type=”text/javascript”>alert(“penta”) ;<script>

In this example, DHTML (XML) parser analyzes <tag>, the start of Tag, and </tag>, the end of Tag, as a single Tag so as to analyze attribute and function of Tag.

That is, while the conventional WAF generally determined <script> tag to be an attack so that the corresponding packet was considered as an attacking packet, the present WAF analyzes the DTHML syntax completed by the recombination of the whole HTTP traffic, so that even though the <script> tag is detected, the WAF dos not process the traffic as an attack, and only if the recombined HTTP traffic is the attacking syntax, the WAF process the traffic as an attack. This reduces the false positive rate considerably.

Additionally, in case of Table 1, according to the present invention, the XML parser analyzes the start and end of the tag as a single tag, and therefore the attribute and function of the tag, so that while the conventional WAF determined the <script> tag to be an attack, the present WAF analyzes the whole recombined HTTP traffic syntaxes and only if the whole recombined HTTP traffic is the attacking syntax, it processes it to be an attack.

TABLE 2
[Second example of a semantic detection engine using a parser]

Injection attacking syntax : (name=”penta” or

name=”security”) and keyword=”pentasec”

Here, since all the results of end nodes are part of SQL, whether of the whole syntaxes to be the SQL syntaxes equals TRUE. That is, in case of a SQL injection attack, one of the famous web attacking methods, the conventional WAFs previously registers an attack pattern of ‘or string=string’ in a storage, so that a modulated SQL injection attack cannot be previously protected, but can only be protected after the attack. However, according to the present invention, all kinds of SQL syntaxes executable in a database management system can be detected, so that even a modulated attack, a new attack and the like can be protected.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of detecting a web application attack, the method comprising:
when packets forming HTTP traffic are received, a web application firewall removing header parts of the respective packets and collecting only payload parts of the packets, and finally recombining the HTTP traffic;
a parser analyzing the recombined HTTP traffic and determining whether or not the recombined HTTP traffic includes the attack-relevant content;
if the recombined HTTP traffic does not include the attack-relevant content, sending the recombined HTTP traffic to a web server or a user server and normally processing the recombined HTTP traffic; and
if the recombined HTTP traffic includes the attack-relevant content, detecting the recombined HTTP traffic as an attack and reprocessing the same in any one of the processes such that the web server or the user server, which transmitted the abnormal packets, is requested to retransmit the packets corresponding to the abnormal packets; the abnormal packets are deleted; or otherwise the abnormal packets are modulated and then transmitted to the web server or the user server.

2. The method according to claim 1, wherein the parser includes an XML parser, which checks the start point and end point of tag for recombined HTTP traffic to confirm the integrity and high/low-order concepts of the XML syntaxes, and determines whether or not the recombined HTTP traffic contains the attack-relevant syntaxes.

3. The method according to claim 1, wherein the parser includes a JavaScript parser, which checks the effectiveness of the JavaScript syntaxes to determine whether or not the recombined HTTP traffic contains the attack-relevant syntaxes.

4. The method according to claim 1, wherein the parser includes a SQL parser, which sub-divides the recombined HTTP traffic into minimal units and checks whether or not the divided units belong to part of the SQL syntaxes to determine whether or not the recombined HTTP traffic contains the attack-relevant syntaxes.

5. The method according to claim 1, wherein the web application firewall performs the modulation so that a message to be suspected of an attack, which is contained in the recombined HTTP traffic, is modulated into a normal message.

6. The method according to claim 1, wherein the web application firewall performs the modulation so that part of a personal information-relevant message among the messages contained in the recombined HTTP traffic is modulated into an externally-unreadable message.
